(19) United States
(12) Patent Application Publication
(10) Pub. No.: US 2025/0385413 A1
(43) Pub. Date: Dec. 18, 2025

(54) MINIATURIZED ON-CHIP FILTER INTEGRATED SWITCH AND RADIO FREQUENCY FRONT END

(71) Applicant: SOUTH CHINA UNIVERSITY OF TECHNOLOGY, Guangzhou City (CN)

(72) Inventors: Jinxu XU, Guangzhou (CN); Shiyu ZHU, Guangzhou (CN); Xiuyin ZHANG, Guangzhou (CN); Huiyang LI, Guangzhou (CN)

(73) Assignee: SOUTH CHINA UNIVERSITY OF TECHNOLOGY, Guangzhou City (CN)

(21) Appl. No.: 19/012,982

(22) Filed: Jan. 8, 2025

(30) Foreign Application Priority Data
Jun. 13, 2024 (CN) 202410757645.3

(51) Int. Cl. H01P 1/203; H04B 1/00

(52) U.S. Cl. CPC H01P 1/203; H04B 1/0078

(57) ABSTRACT

Disclosed are a miniaturized on-chip filter integrated switch and a radio frequency front end. The miniaturized on-chip filter integrated switch includes a first resonator and a second resonator, where the first resonator and the second resonator are symmetrically provided, have the same structure, and are coupled; the first resonator is connected to a signal input port, and the second resonator is connected to a signal output port; each resonator includes a transmission line, and transistors configured to regulate an on-off state are loaded on the transmission line. The integrated design of a filter and a switch, instead of the traditional cascade structure, helps to solve the problems of large size and high loss.

### CROSS REFERENCE TO RELATED APPLICATIONS

Benefit is claimed to Chinese Patent Application No. 202410757645.3, filed on Jun. 13, 2024, the contents of which are incorporated by reference herein in their entirety.

### FIELD

The present disclosure relates to the technical field of wireless communication, and particularly to a miniaturized on-chip filter integrated switch and a radio frequency front end.

### BACKGROUND

In a millimeter wave system, a filter and a switch have the function of frequency selection, serving as two important modules on a front end of a receiver. The switch is configured to control the on-off state of a signal and select a conduction path for the signal. The filter performs band selection to suppress unwanted out-of-band signals. The performances and sizes of the filter and the radio frequency switch have a certain impact on the radio frequency front end circuit. In the traditional design, the filter and the radio frequency switch are designed separately and connected in a cascade manner in the system, often resulting in larger circuit sizes, impedance matching losses, and higher manufacturing costs.

### SUMMARY

In order to overcome the above-mentioned drawbacks and disadvantages of the related art, it is an object of the present disclosure to provide a miniaturized on-chip filter integrated switch.

It is another object of the present disclosure to provide a radio frequency front end.

### BRIEF DESCRIPTION OF THE FIGURES

FIG. 1 is a schematic structural diagram of a miniaturized filter integrated switch of the present disclosure;

FIG. 2 is an S parameter simulation diagram of FIG. 1 of the present disclosure in an on state and an off state.

### DETAILED DESCRIPTION

The integrated design of a filter and a switch of the present disclosure, i.e., integrating the functions of a radio frequency switch and a filter into one assembly, reduces the volume and loss of a transceiver front end.

The objects of the present disclosure are realized by the following technical solutions.

A miniaturized on-chip filter integrated switch is provided, including two resonators, where the first resonator and the second resonator are symmetrically provided, have the same structure, and are coupled; the first resonator is connected to a signal input port, and the second resonator is connected to a signal output port; each resonator includes a transmission line, and transistors configured to regulate an on-off state are loaded on the transmission line.

Further, both ends of the transmission line are grounded.

Further, a gate electrode of the transistor is connected to a bias circuit, and on and off states of the transistor are further controlled by controlling a bias voltage of the gate electrode to realize an off state and an on state of the miniaturized on-chip filter integrated switch.

Further, the gate electrode of the transistor is connected to the bias circuit through a series resistor.

Further, a drain electrode of the transistor is connected to the transmission line or the signal input/output port through a capacitor, and a source electrode of the transistor is grounded; the capacitor is configured to increase an equivalent capacitance when the transistor is in the off state and to form a series resonant circuit with parasitic parameters of the transistor when the transistor is in the on state, thereby enhancing an isolation effect.

Further, the first resonator includes a first transistor, a second transistor, a first transmission line, a first capacitor, and a second capacitor; a drain electrode of the first transistor is connected to the signal input port through the first capacitor, a source electrode of the first transistor is grounded, and a gate electrode of the first transistor is connected with a bias voltage through a resistor;
a drain electrode of the second transistor is connected to the first transmission line through the second capacitor, a source electrode of the second transistor is grounded, and the second transistor is connected with a bias voltage through a resistor.

Further, the second resonator includes a third transistor, a fourth transistor, a second transmission line, a third capacitor, and a fourth capacitor; a drain electrode of the third transistor is connected to the second transmission line through the third capacitor, a source electrode of the third transistor is grounded, and a gate electrode of the third transistor is connected with a bias voltage through a series resistor;
a drain electrode of the fourth transistor is connected to the signal output port through the fourth capacitor, a source electrode of the fourth transistor is grounded, and a gate electrode of the fourth transistor is connected with a bias voltage through a series resistor.

Further, when the first transistor, the second transistor, the third transistor, and the fourth transistor are in the off state, the input admittance of the first resonator and the second resonator is equal to zero, an input signal is effectively transferred from the signal input port to the signal output port, and the filter integrated switch is in the on state.

Further, when the first transistor, the second transistor, the third transistor, and the fourth transistor are in the on state, a signal is isolated, and the filter integrated switch is in the off state.

A radio frequency front end is provided, including the miniaturized on-chip filter integrated switch.

Compared with the related art, the present disclosure has the following advantages and beneficial effects.

The miniaturized on-chip filter integrated switch of the present disclosure includes transistors and transmission lines, and the transmission line is loaded with the transistors to form a resonator. The transistor is configured to regulate the on-off state of the circuit, and two completely symmetrical resonators are coupled to form a filter network.

The transistors' on and off states enable the filter switch to achieve signal's isolation and transmission, which is conducive to reducing the loss and the circuit size, and can reduce the circuit complexity of the transceiver front end.

### EMBODIMENTS

Hereinafter, the present disclosure will be described in further detail with reference to embodiments, but the implementations of the present disclosure are not limited thereto.

### Embodiment 1

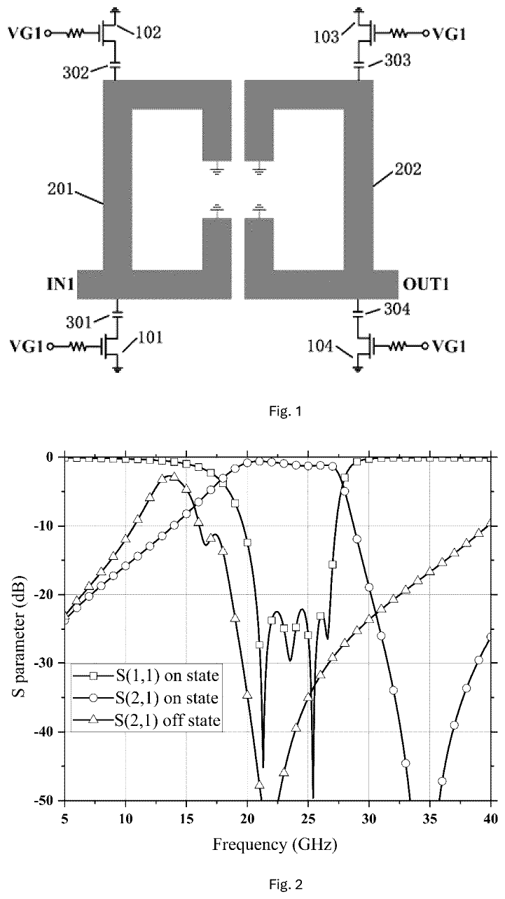

As shown in FIG. 1, a miniaturized on-chip filter integrated switch is provided, including a first resonator and a second resonator. The two resonators are symmetrically provided about the center line of the filter integrated switch, have the same structure, and are coupled to form a filter network so as to realize interference signal suppression. The first resonator is connected to a signal input port, and the second resonator is connected to a signal output port. Each resonator includes a transmission line, and transistors configured to regulate an on-off state are loaded on the transmission line.

The first resonator includes a first transistor 101, a second transistor 102, a first transmission line 201, a first capacitor 301, and a second capacitor 302.

A drain electrode of the first transistor is connected to a signal input port IN1 through the first capacitor 301, a source electrode of the first transistor is grounded, and a gate electrode of the first transistor is connected with a bias voltage VG1 through a series resistor.

A drain electrode of the second transistor is connected to the first transmission line through the second capacitor 302, a source electrode thereof is grounded, and a gate electrode thereof is connected with a bias voltage VG1 through a series resistor. On and off states of the transistor are further controlled by controlling a bias voltage of the gate electrode to realize an off state and an on state of the miniaturized filter integrated switch.

An input signal is isolated in the off state and cannot be transmitted from the input port to the output port. The input signal is transmitted from the input port to the output port in the on state.

The second resonator includes a third transistor 103, a fourth transistor 104, a second transmission line 202, a third capacitor 303, and a fourth capacitor 304. A drain electrode of the third transistor 103 is connected to the second transmission line 202 through the third capacitor 303, a source electrode of the third transistor 103 is grounded, and a gate electrode of the third transistor 103 is connected with a bias voltage VG1 through a series resistor.

A drain electrode of the fourth transistor 104 is connected to a signal output port OUT1 through the fourth capacitor 304, a source electrode of the fourth transistor 104 is grounded, and a gate electrode of the fourth transistor 104 is connected with a bias voltage VG1 through a series resistor.

Further, the first transmission line and the second transmission line have the same structure and both include five microstrip lines connected vertically. Both ends of the first and second transmission lines are grounded, the first transmission line is provided with the signal input port IN1, and the second transmission line is provided with the signal output port OUT1.

Further, the series resistor of the transistor is connected with the bias voltage VG1, and the series resistor is in the kilo-ohm range.

Further, the capacitor in this embodiment is configured to increase an equivalent capacitance when the transistor is in the off state and to form a series resonant circuit with parasitic parameters of the transistor when the transistor is in the on state, thereby enhancing an isolation effect.

An operation process of the above-mentioned filter switch is as follows.

When the first transistor, the second transistor, the third transistor, and the fourth transistor are in the off state, the input admittance of the first resonator and the second resonator is equal to zero, then the input signal is effectively transferred from the signal input port to the signal output port, and the filter integrated switch is in the on state. After the input signal passes through the first resonator and the second resonator, good pass-band return loss and out-of-band suppression are obtained.

When the first transistor, the second transistor, the third transistor, and the fourth transistor are in the on state, the signal is isolated, and the filter integrated switch is in the off state.

In this embodiment, integrated circuit processes such as gallium nitride (GaN), gallium arsenide (GaAs), and CMOS may be used to realize the target function. The first transistor 101, the second transistor 102, the third transistor 103, and the fourth transistor 104 use millimeter wave transistors provided by corresponding processes. The transmission lines are implemented on different metal layers in different processes according to matching and biasing requirements.

FIG. 2 shows an S parameter simulation result of the miniaturized filter integrated switch in the on state and the off state according to the embodiment of the present application. In the on state, in an operating frequency band from 21 GHz to 26.8 GHz, the maximum S₂₁ is −1.1 dB, and S₁₁ in the operating frequency band is less than −10 dB. Below 15 GHz and above 28 GHz, the out-of-band suppression is greater than 12 dB, with a good out-of-band suppression effect. In the off state, in a frequency range of 19 GHz-38 GHz, the isolation is less than −20 dB.

In summary, the miniaturized filter integrated switch of the present disclosure includes transistors and transmission lines. The transmission line is loaded with the transistors to form a resonator. The transistor is configured to regulate the on-off state of the circuit, and two completely symmetrical resonators are coupled to form a filter network. When the input admittance of the resonators is equivalent to zero, interference signal suppression is realized. The integrated design of the filter and the switch of the present disclosure, instead of the traditional cascade structure, helps to solve the problems of large size and high loss.

### Embodiment 2

A radio frequency front end is provided, including the miniaturized filter integrated switch of embodiment 1. The front end includes a first resonator and a second resonator. The two resonators are symmetrically provided about the center line of the filter integrated switch, have the same structure, and are coupled. The first resonator is connected to a signal input port, and the second resonator is connected to a signal output port. Each resonator includes a transmission line, and transistors configured to regulate an on-off state are loaded on the transmission line.

The above-mentioned embodiments are preferred embodiments of the present disclosure, but the implementations of the present disclosure are not limited by the embodiments. Any other changes, modifications, substitutions, combinations, and simplifications made without departing from the spirit and principle of the present disclosure shall be equivalent replacements and are included in the scope of the present disclosure.

We claim:

1. A miniaturized on-chip filter integrated switch, comprising a first resonator and a second resonator, wherein the first resonator and the second resonator are symmetrically provided, have the same structure, and are coupled; the first resonator is connected to a signal input port, and the second resonator is connected to a signal output port; each resonator comprises a transmission line, and transistors configured to regulate an on-off state are loaded on the transmission line.

2. The miniaturized on-chip filter integrated switch according to claim 1, wherein both ends of the transmission line are grounded.

3. The miniaturized on-chip filter integrated switch according to claim 2, wherein a gate electrode of the transistor is connected to a bias circuit, and on and off states of the transistor are further controlled by controlling a bias voltage of the gate electrode to realize an off state and an on state of the miniaturized filter integrated switch.

4. The miniaturized on-chip filter integrated switch according to claim 3, wherein the gate electrode of the transistor is connected to the bias circuit through a series resistor.

5. The miniaturized on-chip filter integrated switch according to claim 1, wherein a drain electrode of the transistor is connected to the transmission line or the signal input/output port through a capacitor, and a source electrode of the transistor is grounded; the capacitor is configured to increase an equivalent capacitance when the transistor is in the off state and to form a series resonant circuit with parasitic parameters of the transistor when the transistor is in the on state, thereby enhancing an isolation effect.

6. The miniaturized on-chip filter integrated switch according to claim 1, wherein the first resonator comprises a first transistor, a second transistor, a first transmission line, a first capacitor, and a second capacitor; a drain electrode of the first transistor is connected to the signal input port through the first capacitor, a source electrode of the first transistor is grounded, and a gate electrode of the first transistor is connected with a bias voltage through a resistor;
a drain electrode of the second transistor is connected to the first transmission line through the second capacitor, a source electrode of the second transistor is grounded, and the second transistor is connected with a bias voltage through a resistor.

7. The miniaturized on-chip filter integrated switch according to claim 6, wherein the second resonator comprises a third transistor, a fourth transistor, a second transmission line, a third capacitor, and a fourth capacitor; a drain electrode of the third transistor is connected to the second transmission line through the third capacitor, a source electrode of the third transistor is grounded, and a gate electrode of the third transistor is connected with a bias voltage through a series resistor;
a drain electrode of the fourth transistor is connected to the signal output port through the fourth capacitor, a source electrode of the fourth transistor is grounded, and a gate electrode of the fourth transistor is connected with a bias voltage through a series resistor.

8. The miniaturized on-chip filter integrated switch according to claim 7, wherein when the first transistor, the second transistor, the third transistor, and the fourth transistor are in the off state, the input admittance of the first resonator and the second resonator is equal to zero, an input signal is effectively transferred from the signal input port to the signal output port, and the filter integrated switch is in the on state.

9. The miniaturized on-chip filter integrated switch according to claim 7, wherein when the first transistor, the second transistor, the third transistor, and the fourth transistor are in the on state, a signal is isolated, and the filter integrated switch is in the off state.

10. A radio frequency front end, comprising the miniaturized on-chip filter integrated switch according to claim 1.
